(19) United States
(12) Patent Application Publication
(10) Pub. No.: US 2016/0132650 A1
(43) Pub. Date: May 12, 2016

(54) Nursing Home Bed Reservation System

(71) Applicants: Kamal Kejriwal, Redlands, CA (US); Rajesh Bhageria, Loveland, OH (US)

(72) Inventors: Kamal Kejriwal, Redlands, CA (US); Rajesh Bhageria, Loveland, OH (US)

(21) Appl. No.: 14/996,157

(22) Filed: Jan. 14, 2016

Related U.S. Application Data
(63) Continuation-in-part of application No. 14/108,172, filed on Feb. 14, 2014.

(51) Int. Cl. G06F 19/00

(52) U.S. Cl. CPC G06F 19/327

(57) ABSTRACT

A system for managing discharge of patients from a hospital to a nursing care facility has the steps of a nursing facility registers on the database, the nursing facility providing real-time updates on a current bed availability, the database is updated with the bed availability as well as features of the available bed, an up-to-date view of bed availability is provided to a hospital case managers view bed availability, and the patient is discharged and sent to the available bed. The features are selected from the group consisting of gender, isolation beds, subacute conditions, custodial beds and the presence of a ventilator. The system may also have the step of placing a biomonitoring device on a patient and monitoring the patient. Monitoring the patient may include locating the patient within the facility, monitoring vital functions, and monitoring for early stroke detection.

### CROSS-REFERENCE TO RELATED APPLICATION

The present application is a Continuation-in-Part Application of U.S. Non-Provisional Patent Application No. 14/108,172 filed on Feb. 14, 2014, entitled “Improving Patient Transition by Web Based program to have real time availability of Skilled nursing home beds”, the entire disclosure of which is incorporated by reference herein.

### BACKGROUND OF THE INVENTION

1. Field of Invention

The present invention relates to the field of automated systems to facilitate nursing home bed reservations and transfers.

2. Description of Related Art

The current system for discharging a patient from a hospital to a nursing home or other alternative care facility oftentimes delays patient discharge, resulting in unnecessary prolonged occupancy of hospital beds. Currently, when the patient is ready to be discharged from the hospital, the hospital's discharge planners call the local network nursing care facilities to determine both the specific care needs the facilities are equipped to provide and their respective bed availability. In addition to being an unduly burdensome and time-consuming process, if the discharge planners attempt to contact the nursing care facilities after hours or on a weekend, they are unable to reach the appropriate staff to determine the facilities' bed availability. Only after bed availability has been determined and a decision on facility choice has been made, will the patient be discharged to the respective facility. This unnecessarily ties up hospital beds and other resources, as the hospital administrators wait for notification that a bed is available.

Based on the foregoing, there is a need in the art for a system that enables hospitals to check real-time availability of care facility beds, thus eliminating unnecessary delay of patient discharge from the hospital to the care facility.

### SUMMARY OF THE INVENTION

In a system for managing discharge of patients from a hospital to an alternative care facility, the nursing care facilities register on a website and provide real-time updates of their current bed availability. The hospital case managers and discharge planners have access to the website, allowing them to view real time bed availability at the registered facilities at any given time. This allows patients who are ready for, or are anticipating, discharge from the hospital to be discharged to an appropriate care facility in an efficient manner, thus increasing hospital bed availability for incoming patients. Furthermore, in the event the patient requires skilled care, the patient is able to transition to the care facility and begin skilled nursing treatment sooner.

A system for managing discharge of patients from a hospital to a nursing care facility has the steps of a nursing facility registers on the database, the nursing facility providing real-time updates on a current bed availability, the database is updated with the bed availability as well as features of the available bed, an up-to-date view of bed availability is provided to a hospital case managers view bed availability, and the patient is discharged and sent to the available bed.

The features are selected from the group consisting of gender, isolation beds, subacute conditions, custodial beds and the presence of a ventilator. The system may also have the step of placing a biomonitoring device on a patient and monitoring the patient. Monitoring the patient may include locating the patient within the facility, monitoring vital functions, and monitoring for early stroke detection.

The vital functions monitored are selected from the group consisting of pulse rate, respiration rate, blood oxygen levels, blood glucose levels, and tremors, The system may have early stroke detection that includes monitoring a baseline and notifying the patient if the patient vitals move away from the baseline.

Locating the patient within the facility has transmitters on patients providing location of the patient with reference to anchor nodes. In an embodiment, the patient may select a particular location within the facility based on a floorplan of the facility. If multiple facilities have available beds then the patient or the patients' family selects the facility from the multiple facilities.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a flowchart of the method, according to an embodiment of the present invention; and

FIG. 2 is a functional diagram of the system, according to an embodiment of the present invention.

### DETAILED DESCRIPTION OF PREFERRED EMBODIMENTS

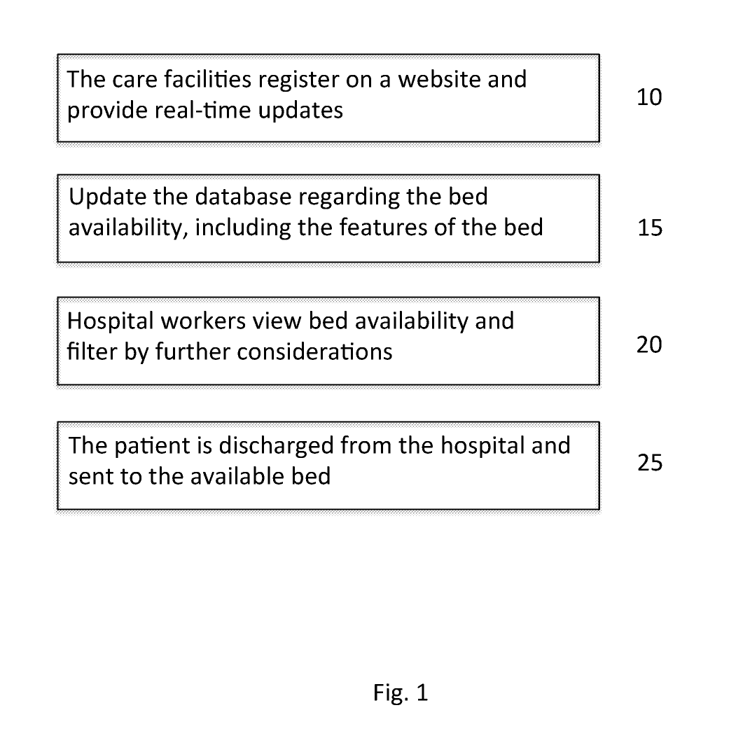

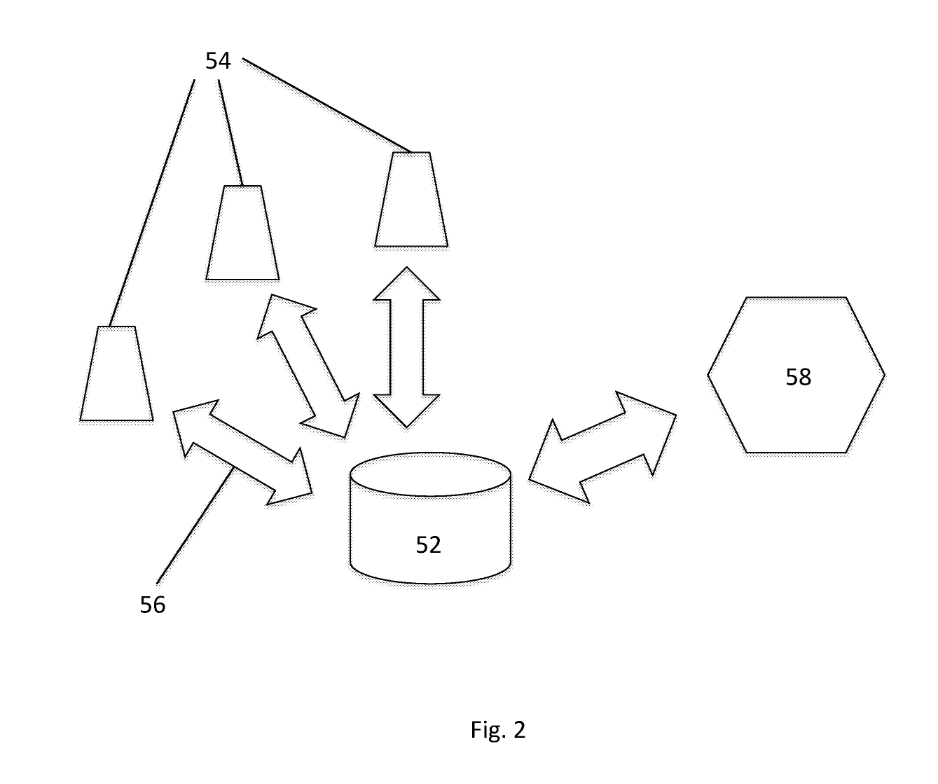

Preferred embodiments of the present invention and their advantages may be understood by referring to FIGS. 1-2, wherein like reference numerals refer to like elements.

With reference to FIG. 1, and in a system for managing discharge of patients from a hospital to an alternative care facility, in step 10 the nursing care facilities register on a website and provide real-time updates of their current bed availability. In an embodiment, the connections from the nursing care facilities to the database are secure tunnels or VPNs. The website is connected to a database at its back end and in step 15 updates the database regarding the bed availability, including the features of the bed available, including whether the beds are for males or females, if they are isolation beds for certain conditions, the total capacity of facility to ensure every bed is accounted for, subacute conditions that may be treated in the bed, the presence of long-term custodial beds and the presence of a ventilator. The data is updated in real time to provide an up-to-date view of the bed availability in various nursing care facilities, and may be updated automatically by interfacing with the nursing home database.

In an embodiment the data on patients is received by means of an electronic biomonitoring device that fits on or implanted within the patient's body and monitors presence (through an indoor GPS) as well as vital functions such as pulse rate, respiration rate and oxygen levels, temperature, blood pressure, blood glucose levels, tremors early stroke or seizure detection. The early stroke detection monitors the body for a baseline and shocks the body if the monitored vitals move outside of the normal range, potentially indicating a stroke or heart attack. The collected data is sent data wirelessly to the database.

The indoor GPS or indoor positioning system may operate by RFID, Bluetooth or Wi-Fi transmitters on the patients and anchor nodes at known locations within the indoor space.

In step 20 the hospital case managers and discharge planners have access to the website, allowing them to view bed availability at the registered facilities at any given time, with the ability to sort by patient gender, and whether an isolation bed, subacute conditions treatment or a ventilator is required, for example. This allows patients who are ready for, or are anticipating, discharge from the hospital to be discharged to an appropriate care facility in an efficient manner avoiding delays, thus increasing hospital bed availability for incoming patients. If only one bed is available, the patient has no choice and is assigned to that bed, with the purpose of clearing up bed space in the hospital. This is particularly useful for freeing up beds on the weekend, as in the prior art manual process, beds are only reported as empty during the week. If beds available in more than one alternative care facility that meet the patient's needs, the patient or patient's family are given options on which nursing home to go to. If they don't make a choice, and remain in the hospital, further charges will be incurred by the hospital.

Once a bed is identified, at step 25 the patient is discharged from the hospital and sent to the available bed. Furthermore, in the event the patient requires skilled care not available at the hospital, the patient is able to transition to the care facility and begin skilled nursing treatment sooner. The patient's bed may be located by maps within an overview of the facility floorplan, or using indoor GPS, and the patient of patient's family may select a particular location within the nursing care facility for the patient. Some patients would prefer to be closer to the nurses' station, while others may want to be out of the way in a corner.

With reference to FIG. 2, the database is shown with connections from all the nursing care facilities. Further, secure hospital connections with the database permit the hospital to see bed availability in real time communication, instantaneously monitoring bed availability in a network of nursing homes.

The criteria that are considered in a decision on whether available beds are, for example, patient gender, and whether an isolation bed, subacute conditions treatment or a ventilator is required. Other possible considerations are long term stay beds.

With reference to FIG. 2, once the decision is made to discharge the patient from the hospital, the discharge planners will go on the created website where they will have a real time updates of the nursing home bed availability in the geographical area. They can secure that bed on the secure website, which will help in early and safe transition of patient from hospital to nursing home. The database 52 contains the data records on available beds in real-time. The nursing facilities 54 are connected to the database securely via encrypted connections 56 such as VPN or secure tunnels. Data is provided by the facilities as soon as the bed situation changes, so as to maintain the database in an up-to-date form. The hospital 58 queries the database according to the criteria when a patient is ready for discharge to a bed, and the database returns the location of a bed through a secure connection.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A system for managing discharge of patients from a hospital to a nursing care facility, comprising the steps of:
a. a nursing facility registers on the database;
b. the nursing facility providing real-time updates on a current bed availability;
c. the database is updated in real-time with the bed availability as well as features of the available bed;
d. an real-time view of bed availability and features is provided to a hospital having case managers;
e. hospital case managers view bed availability for a patient; and
f. the patient is discharged and sent to the available bed.

2. The system of claim 1 wherein the features are selected from the group consisting of gender, isolation beds, subacute conditions, custodial beds and the presence of a ventilator.

3. The system of claim 1 further comprising the steps of placing a biomonitoring device on a patient and monitoring the patient.

4. The system of claim 3 wherein monitoring the patient comprises locating the patient within the facility, monitoring vital functions, and monitoring for early stroke detection.

5. The system of claim 4 wherein the vital functions are selected from the group consisting of pulse rate, respiration rate, blood oxygen levels, blood glucose levels, and tremors.

6. The system of claim 4 wherein early stroke detection comprises monitoring a baseline and notifying the patient if the patient vitals move away from the baseline.

7. The system of claim 4 wherein locating the patient within the facility has transmitters on patients providing location of the patient with reference to anchor nodes.

8. The system of claim 4 wherein the location of the patient is used to automatically update the bed database.

9. The system of claim 1 wherein the patient may select a particular location within the facility based on a floorplan of the facility.

10. The system of claim 1, wherein is multiple facilities have available beds then the patient or the patients' family selects the facility from the multiple facilities.

11. The system of claim 1 wherein the case managers search for a bed with particular features.
